(19) United States
(12) Patent Application Publication
(10) Pub. No.: US 2026/0064358 A1
(43) Pub. Date: Mar. 5, 2026

(54) METHODS AND SYSTEMS FOR IMPROVED DISCRETE AUDIO PLAYBACK

(71) Applicants: Jimmy Lee Lentz, JR., Murfreesboro, TN (US); Helen Vanessa Lentz, Murfreesboro, TN (US)

(72) Inventors: Jimmy Lee Lentz, JR., Murfreesboro, TN (US); Helen Vanessa Lentz, Murfreesboro, TN (US)

(21) Appl. No.: 19/229,242

(22) Filed: Jun. 5, 2025

Related U.S. Application Data
(60) Provisional application No. 63/688,870, filed on Aug. 30, 2024.

(51) Int. Cl. G06F 3/16; G06F 16/635; G10L 15/183; G10L 15/30; H04R 1/10

(52) U.S. Cl. CPC G06F 3/165; G06F 3/162; G06F 16/635; G10L 15/183; G10L 15/30; H04R 1/1016; H04R 2420/07

(57) ABSTRACT

Described herein are methods and system for discrete audio playback. The system may comprise a wireless earpiece configured to receive audio signals wirelessly and a media hub configured to wirelessly transmit audio signals to the wireless earpiece. An audio device may be configured to store and play back pre-recorded audio files. A control mechanism, such as a microswitch, may allow for discreet control of audio playback from the audio device. The system may enable wireless operation, concealed controls, customizable audio support, and enhanced mobility for users such as public speakers and broadcasters. It may reduce the need for visible prompting devices or extensive memorization in some aspects.

### CROSS-REFERENCE TO RELATED PATENT APPLICATION

This application claims priority to U.S. Prov. App. No. 63/688,870, filed on Aug. 30, 2024, the entirety of which is incorporated by reference herein.

### BACKGROUND

Prompting methods and devices have long been used in television studios, film sets, and public speaking environments to assist presenters in delivering content. Traditional teleprompters display text on screens for speakers to read, while ear prompters transmit audio cues to an earpiece. However, these systems often restrict movement, require fixed positioning, or involve visible equipment that can distract audiences. Additionally, many existing solutions necessitate physical connections like neck loops and wires, limiting wardrobe choices and user comfort. As presentations and broadcasts evolve, there is a growing need for more discreet, flexible, and user-friendly prompting solutions that allow speakers to move freely, maintain audience engagement, and deliver content naturally without relying on visible aids or extensive memorization. These and other considerations are discussed herein.

### SUMMARY

It is to be understood that both the following general description and the following detailed description are exemplary and explanatory only and are not restrictive.

Methods and systems described herein may provide improved discrete audio playback, such as for public speakers, broadcasters, etc. The methods and systems may be used to give a presentation in various professional settings, such as conferences, business meetings, academic lectures, etc. As an example, a user may select content using an audio device. This content may include key talking points, transitions, or entire sections of a speech. Before the presentation, the user may position a wireless earpiece discreetly in their ear. A media hub may be connected to the audio device and placed in a nearby location, such as a pocket or on a nearby surface, depending on the chosen operating mode. A control mechanism, which may include a remote fob and microswitch, may be concealed on the user's person, such as in a pocket or attached to clothing. As the user begins their presentation, they may activate the audio playback using the control mechanism. The system may then transmit the pre-recorded audio content wirelessly to the earpiece, allowing the user to hear their prepared remarks without visible cues.

Throughout the presentation, the user may control the audio playback using the discreet control mechanism. This may allow them to pause, resume, or skip sections of the audio as needed, providing flexibility to adapt to time constraints or audience reactions. The wireless nature of the system may enable the user to move freely around the presentation space, enhancing audience engagement and allowing for more dynamic delivery. The system may be particularly useful for presentations that require precise wording or technical information, as it may reduce the cognitive load of memorization. It may also assist in maintaining a consistent pace and structure throughout the presentation. The discreet nature of the system may help maintain the audience's focus on the user and the content, rather than on visible prompting devices.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, together with the description, serve to explain the principles of the present methods and systems:

FIG. 1 shows an example system;

FIG. 2 shows an example view of the system of FIG. 1;

FIG. 3 shows an example audio device;

FIG. 4 shows an example view of the audio device of FIG. 3;

FIG. 5 shows an example view of the audio device of FIG. 3;

FIG. 6 shows an example view of the audio device of FIG. 3;

FIG. 7 shows an example earpiece;

FIGS. 8A-8B show example views of a remote fob, a microswitch, and a trunkline connector;

FIGS. 8C-8E show further example views of the remote fob and the microswitch;

FIGS. 8F-8P show further examples of the microswitch;

FIGS. 9A-9B show example views of a media hub;

FIGS. 10A-10B show example configurations of the system of FIG. 1;

FIG. 11 shows an example system/environment;

FIG. 12 shows a flowchart of an example method; and

FIG. 13 shows a flowchart of an example method.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers, or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application, reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general-purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

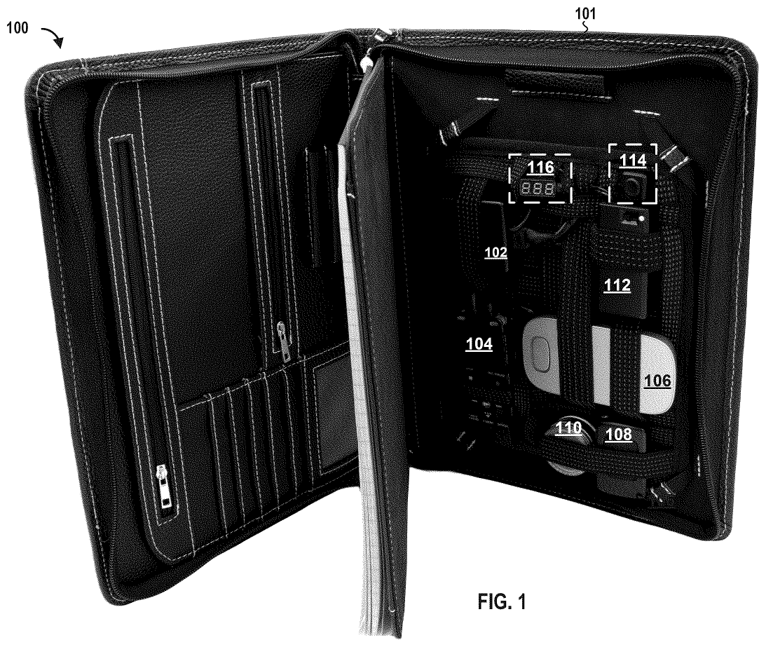

Provided herein are methods and systems for discrete audio playback. Referring to FIG. 1, a system 100 for discrete audio playback is shown. The system 100 may comprise several components organized within a container 101, in some example configurations, to allow for easy access and efficient use of space. In some aspects, the container 101 may feature a textured surface and include elastic straps to secure various components in place. However, the container 101 shown is merely exemplary, and the system 100 may utilize alternative container designs. For instance, a hard-shell carrying case could provide enhanced protection for the components during transport. Alternatively, a backpack or messenger bag style container could allow hands-free carrying when the system is not in use. In some variations, the container 101 may incorporate modular, removable compartments to allow users to customize the internal layout based on their specific needs or preferences. The modular approach may also facilitate easy replacement of individual sections if they become damaged or worn over time. Other example configurations of the system 100 are possible as well, such as use of the system 100 without the container 101, as further described herein.

The system 100 may include a receiver, such as the receiver 102 positioned on the left-hand side of the container 101 as shown in FIG. 1. The system 100 may include an audio device, such as the audio device 104 as shown in FIG. 1 located in a lower left portion of the container 101. The system 100 may include a media hub, such as the media hub 106 situated in a right central area of the container 101 as shown in FIG. 1. The system 100 may include a remote fob, such as the remote fob 108 secured in a lower right corner in FIG. 1. The receiver 102 may be configured to receive wireless signals from the remote fob 108 using various protocols. In some variations, the receiver 102 may support multiple wireless standards, such as Bluetooth, Wi-Fi, and proprietary protocols, etc.

The system 100 may comprise an earpiece, such as the earpiece 110 shown in FIG. 1 held in place by an elastic strap in a lower central area of the container 101. The earpiece 110 may receive output signals/streams via the media hub 106 as further described herein. A battery 112 may be positioned in an upper right corner, with an adjacent battery life indicator button 114 to activate a battery life indicator 116, for example. The battery life indicator 116 may display a digital readout of remaining charge, and it may be located in an upper central portion of the container 101 as shown in FIG. 1.

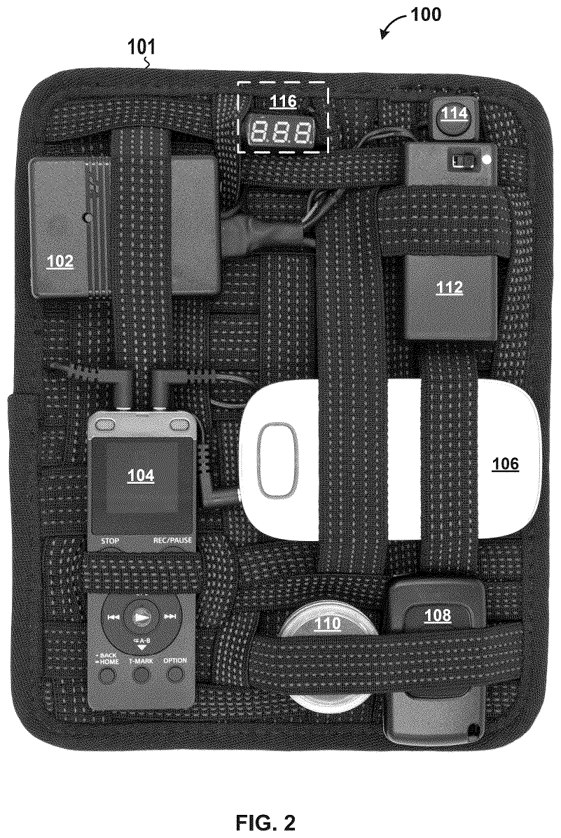

FIG. 2 shows an example sectional view of the system 100, focusing on the elements of the system 100 within the container 101. As described throughout herein, the system 100 may be particularly useful for presentations that require precise wording or technical information, as it may reduce the cognitive load of memorization, etc. The system 100 may also assist in maintaining a consistent pace and structure throughout the presentation. The discreet nature of the system 100 may help maintain the audience's focus on the user and the content, rather than on visible prompting devices.

In comparison to existing solutions, the present system 100 may offer several advantages. For example, traditional teleprompters often restrict a speaker's movement and require fixed positioning, which can limit audience engagement. The present system's 100 wireless nature may allow for greater mobility and more natural interaction with the audience. Additionally, many existing ear prompters involve visible equipment or physical connections like neck loops and wires, which can be distracting and limit wardrobe choices. The present system's 100 discreet components and wireless design may provide greater flexibility in attire selection and improved comfort for extended wear.

Furthermore, the present system 100 may offer improvements in terms of user control and customization. Unlike some existing solutions that require a second person or audio technician to operate, the system 100 may allow the user complete autonomy over their audio playback. The ability to pre-record and easily access specific sections of a presentation may provide greater precision and flexibility compared to general audio cue systems. Additionally, the system's 100 compact and self-contained nature may also offer advantages in terms of portability and case of setup. This may be particularly beneficial for users who frequently present in different locations or have limited preparation time. The system's 100 design may allow for quick deployment and minimal visible equipment, which can be advantageous in professional settings where a polished appearance is important.

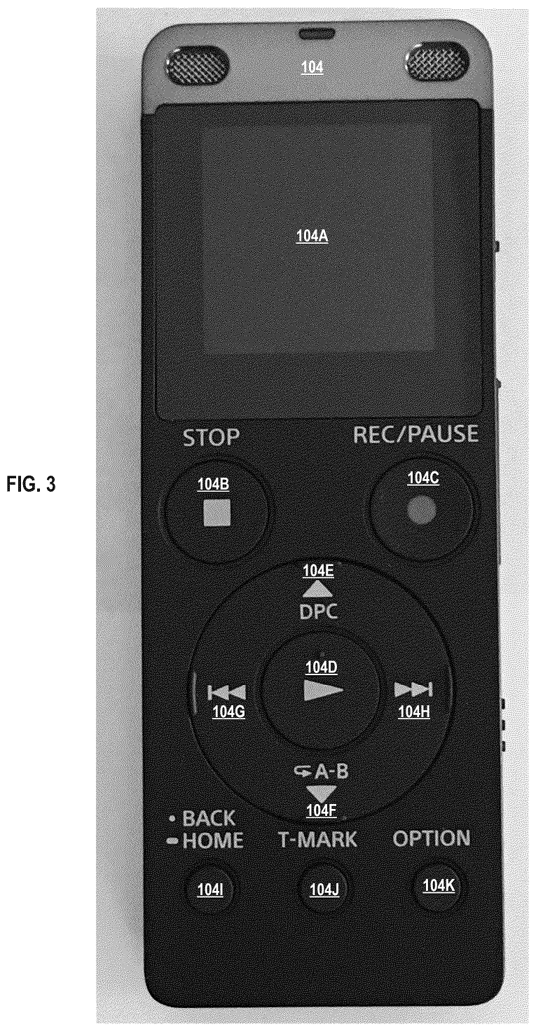

Referring to FIG. 3, an example front view of the audio device 104 is shown. The audio device 104 may comprise a display 104A positioned at the top portion. Below the display 104A, the audio device 104 may feature several control buttons. A stop button 104B may be located on the left side, while a record button 104C may be positioned on the right side. These buttons may be circular in shape and labeled “STOP” and “REC/PAUSE” respectively. Beneath these buttons, a circular control pad may be present. The control pad may include an up button 104E at the top, a down button 104F at the bottom, a left button 104G on the left side, and a right button 104H on the right side. A play button 104D may be positioned at the center of this circular pad. At the bottom of the audio device 104, there may be three additional buttons. From left to right, these may be a back/home button 104I, a mark button 104J, and an option button 104K.

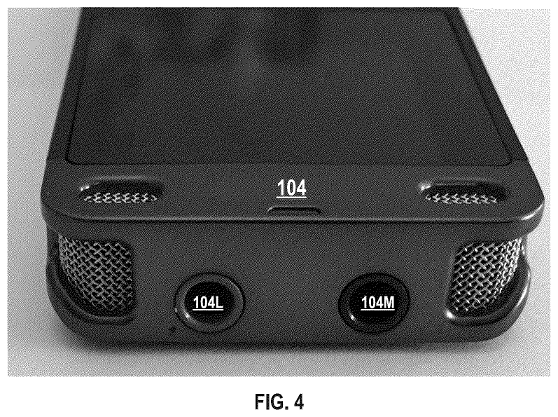

Referring to FIG. 4, an example view of a top portion of the audio device 104 is shown. The audio device 104 may feature two circular ports. The left port may be labeled as input jack 104L and the right port may be labeled as output jack 104M. In some aspects, these jacks may serve as connection points for audio input and output respectively. In some variations, these jacks (and/or any other input/jack of the audio device 104) may be specially configured to perform additional or different functions, as further described herein. The input jack 104L may be used to connect external audio sources or microphones to the audio device 104. For example, the input jack 104L may be used to connect the receiver 102, which may cause playback of audio via the audio device 104 when the remote fob 108 is engaged as further described herein. The output jack 104M may be used to connect headphones, speakers, or other audio output devices to the audio device 104. For example, the output jack 104M may be used to connect the media hub 106 to receive audio streams/signals, which may in turn be output via the earpiece 110 as further described herein. In some variations, the audio device 104 may include additional ports or connections. For example, the audio device 104 may include one or more microphones (not shown), such as near at the top corners, next to the input jack 104L and/or the output jack 104M. The speaker is located on the bottom end, next to the USB. It does not function when a cable is plugged into the audio jack 104M.

In some variations, the input jack 104L (and/or any other input/jack of the audio device 104) may be specially configured to perform additional or different functions, aside from being an audio input jack. For example, the input jack 104L (and/or any other input/jack of the audio device 104) may be specially configured to enable the input jack 104L to serve as a connection point to the receiver 102, which may cause playback of the audio device 104 as described herein.

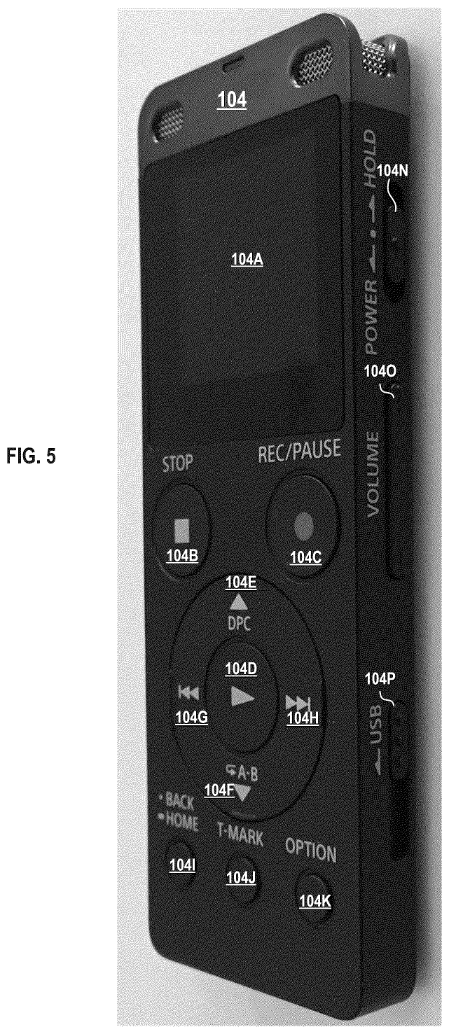

Referring to FIG. 5, a perspective view of the audio device 104 is shown. On the right side of the audio device 104, there may be three features visible. At the top, a power/hold switch 104N may be present. Below this, a volume button 1040 may be located. At the bottom of the right side, a USB connection release 104P may be positioned. In some variations, the audio device 104 may include a speaker(s) nearby the USB connection release 104P (e.g., the bottom of the audio device 104) and/or elsewhere. The power/hold switch 104N may serve multiple functions. In some cases, it may be used to power the audio device 104 on and off. In other aspects, it may be used to lock the audio device 104 controls to prevent accidental button presses during use. The volume button 1040 may allow users to adjust the playback volume of the audio device 104. In some variations, the volume button 1040 may be a rocker switch, allowing users to increase or decrease volume by pressing different ends of the button. The USB connection release 104P may be used to expose or retract a USB connector. This feature may allow for easy connection to computers or other devices for data transfer or charging purposes. In some aspects, the USB connection may be protected when not in use, enhancing the durability of the audio device 104.

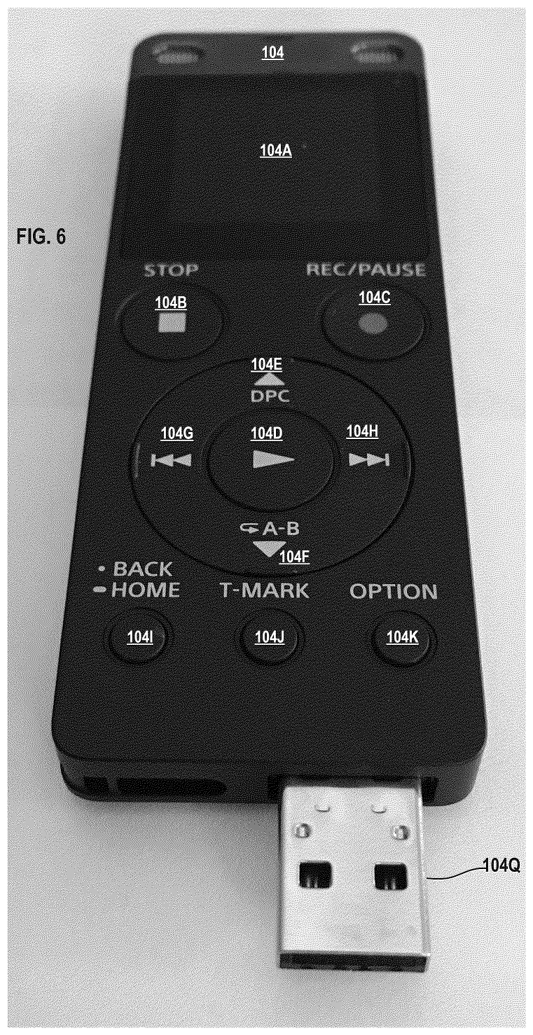

Referring to FIG. 6, an example front view of the audio device 104 is shown. As mentioned above, the USB connection release 104P may be used to expose or retract a USB connector, such as the USB connection 104Q shown in FIG. 6. The USB connection 104Q may be used to connect to other devices for data transfer or charging purposes, etc. The audio device 104 may incorporate multiple connection protocols beyond USB, such as Thunderbolt, Lightning, or USB-C, to enhance compatibility with a wider range of devices and enable faster data transfer speeds. In addition to the physical USB connection 104Q, the audio device 104 may feature wireless data transfer capabilities using technologies like Wi-Fi Direct, NFC, or Bluetooth, allowing for cable-free synchronization and file sharing. In some examples, the USB connection 104Q may be designed to support external storage devices, enabling users to expand the audio device's 104 capacity with USB flash drives or portable hard drives. Additionally, or in the alternative, the audio device 104 may include a dedicated external storage slot (e.g., an SD card slot, etc.)

Furthermore, in some examples, the USB connection 104Q may be used to turn the audio device 104 into a portable audio interface, allowing it to serve as a high-quality microphone or digital-to-analog converter when connected to a computer. In some aspects, the audio device 104 may incorporate a larger battery and bidirectional USB-C connectivity, enabling it to function as a power bank to charge other devices when needed. The USB connection 104Q may be designed to interface with a custom docking station, providing additional functionality such as enhanced audio output, charging, and connectivity to other peripherals. The USB connection 104Q may facilitate easy firmware updates, allowing users to enhance the device's functionality and security over time without the need for specialized equipment. In some cases, the USB connection 104Q may incorporate hardware-level encryption for secure data transfer, ensuring that sensitive audio files remain protected during transmission between devices. The USB connection 104Q may be designed to accept modular add-ons, such as specialized microphones, speakers, or control interfaces, expanding the device's capabilities for specific use cases.

In some aspects, the audio device 104 may have customized firmware and/or software. The audio device 104 may be used to record and/or store audio files (e.g., pre-recorded content, such as presentations, scripts, etc.) for later playback. Playback of audio stored on the audio device 104 may be started via the remote fob 108, which may be activated by a microswitch as further described herein. The remote fob 108, once activated, may send a signal to the receiver 102 to cause the audio device 104 to start (or stop) playback of the audio, and the output signal/stream from the audio device 104 may be received by the media hub 106 via the output jack 104M.

While the audio device 104 shown in FIGS. 3-6 may be a specific model, such as a Sony™ ICD-UX560 digital voice recorder, other types of audio devices may be used as well. In some aspects, alternative devices may be used in place of the depicted audio device 104. For example, the audio device 104 may be a smartphone or tablet with audio recording capabilities and appropriate output jacks (or an appropriate peripheral device providing output jacks) which can serve as versatile alternatives, using their built-in storage, processing power, and user-friendly interfaces. These devices often come with high-quality microphones and the ability to run specialized audio recording apps, making them suitable for users who prefer a familiar interface.

In other cases, the audio device 104 may be a portable digital audio player with recording functions. The audio device 104 may also be a custom-built or modified device. In some cases, the audio device 104 may have a touchscreen interface instead of physical buttons, allowing for a more customizable user interface. As a further example, the audio device 104 may be a portable digital audio player with recording functions, offering a compact solution that combines playback and recording capabilities. These devices typically feature long battery life and are designed for optimal audio performance, making them ideal for extended use during presentations or broadcasts.

Additionally, dedicated professional-grade audio recorders provide advanced features such as high-quality preamps, XLR inputs, and support for multiple audio formats. These devices are particularly suitable for users who require superior audio fidelity or need to work in challenging acoustic environments. Small form-factor computers or single-board computers with audio capabilities offer a highly customizable solution. These devices can be programmed to perform specific audio tasks and can be easily integrated into custom enclosures, making them ideal for users with unique requirements or those who need to develop specialized audio solutions. The system's 100 flexibility in accommodating various audio devices enhances its adaptability to different user preferences and situational requirements.

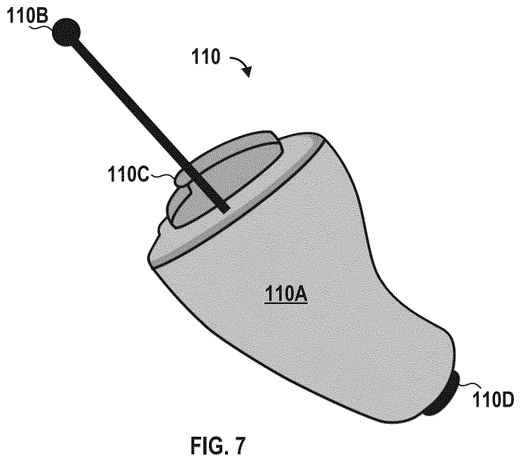

Referring to FIG. 7, an example earpiece 110 is shown. The earpiece 110 may comprise several components, including an earpiece body 110A, a removal element 110B (e.g., to easily remove the earpiece 110), a battery 110C, and an output 110D. The earpiece body 110A may form the main structure of the earpiece 110. The earpiece body 110A may have a curved, elongated shape. This shape may be designed to fit comfortably in a user's ear. The design of the earpiece 110 may prioritize a compact and discreet form factor to allow for comfortable wear and inconspicuous use. The curved shape of the earpiece body 110A may be designed to conform to the natural contours of the human ear. In some examples, the earpiece body 110A may be specially-designed for the left ear versus the right ear, the earpiece body 110A may be custom-molded for a particular user, and/or the earpiece body 110A may be it may be a “universal” fit for either ear. The earpiece body 110A may house the internal components and provide structural support.

The earpiece 110 may comprise an internal antenna (not shown in FIG. 7), The internal antenna may be used for wireless communication with other components of the system 100, such as the media hub 106. In some aspects, the internal antenna may be designed to optimize signal reception and transmission while maintaining a compact form factor. The internal antenna may be designed to support multiple wireless communication protocols. In some cases, the internal antenna may enable Bluetooth connectivity in addition to proprietary wireless protocols used by the system 100, for example. This multi-protocol support may enhance the versatility of the earpiece 110, allowing it to connect with a wider range of devices when needed. In some examples, though not shown in FIG. 7, the earpiece 110 may comprise an external antenna that functions in a similar manner as the internal antenna described herein.

A battery 110C may be inserted at the top of the earpiece body 110A, where the removal element 110B connects to the main body 110A. The battery 110C may power the earpiece 110 and its various functions. In some cases, the battery 110C may be rechargeable. The battery 110C may be designed to provide extended use time while maintaining a small size to fit within the compact earpiece 110. At the bottom end of the earpiece body 110A, an output 110D may be present. In some examples of the earpiece 110, such as the example shown in FIG. 7, the output 110D may comprise a covering element(s), such as disposable wax, padding, or similar, and an output element(s), such as a speaker or similar, may be underneath and/or within the covering element(s). The covering element(s) may be for added for purposes of comfort and/or to protect the output element(s) of the earpiece 110. The output 110D may deliver sound directly into the user's ear canal. In some aspects, the output 110D may be designed to provide clear, high-quality audio while maintaining user comfort. The output 110D may be customizable in certain variations of the earpiece 110. For example, the earpiece 110 may include interchangeable ear tips of various sizes and materials to accommodate different ear shapes and user preferences.

In some variations, the earpiece 110 may incorporate additional features. For example, the earpiece 110 may include a microphone for two-way communication or voice commands. The earpiece 110 may also feature touch-sensitive controls on the earpiece body 110A for adjusting volume or changing audio tracks, in some examples. In certain aspects, the earpiece 110 may incorporate noise-cancellation technology. This technology may help to isolate the audio playback from ambient noise, enhancing the clarity of the audio cues or prompts delivered to the user. Further, in some examples, the earpiece 110 may utilize bone conduction technology, transmitting audio through the bones of the skull and leaving the ear canal open for ambient sound. This could be beneficial for users who need to maintain awareness of their surroundings. Alternatively, the earpiece 110 may be designed as a nearly invisible, completely-in-canal (CIC) device for maximum discretion.

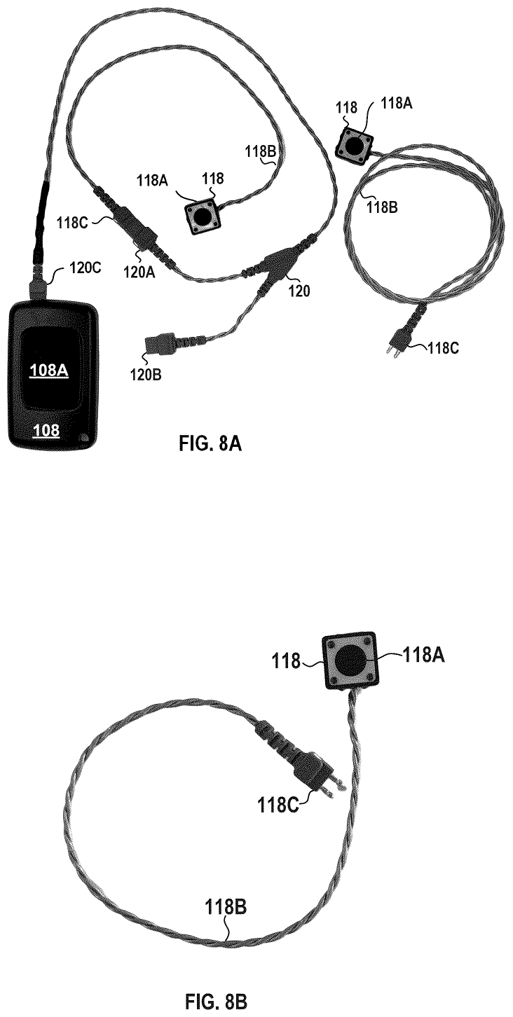

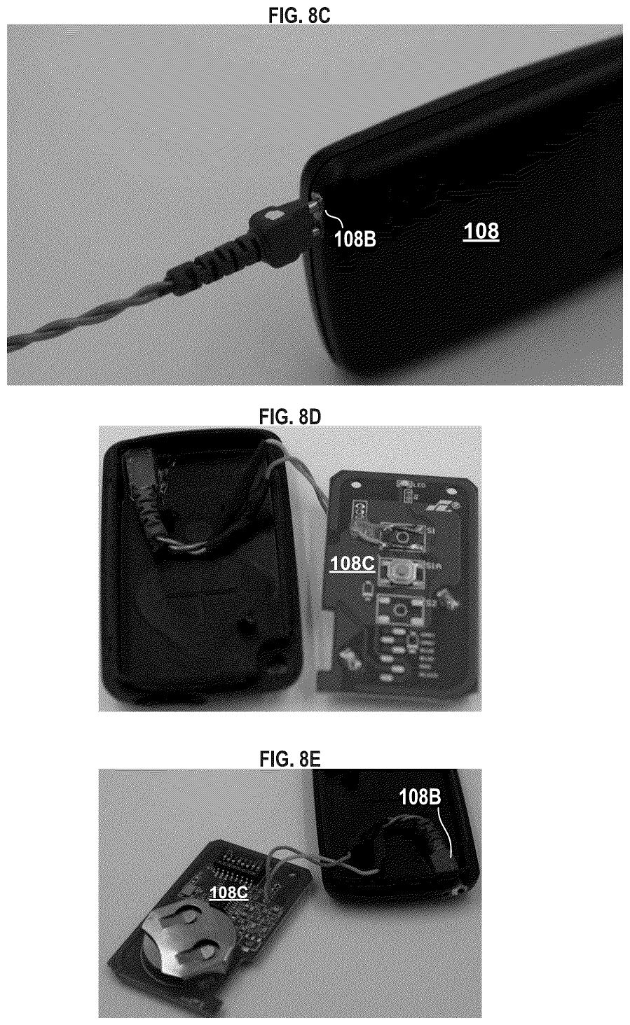

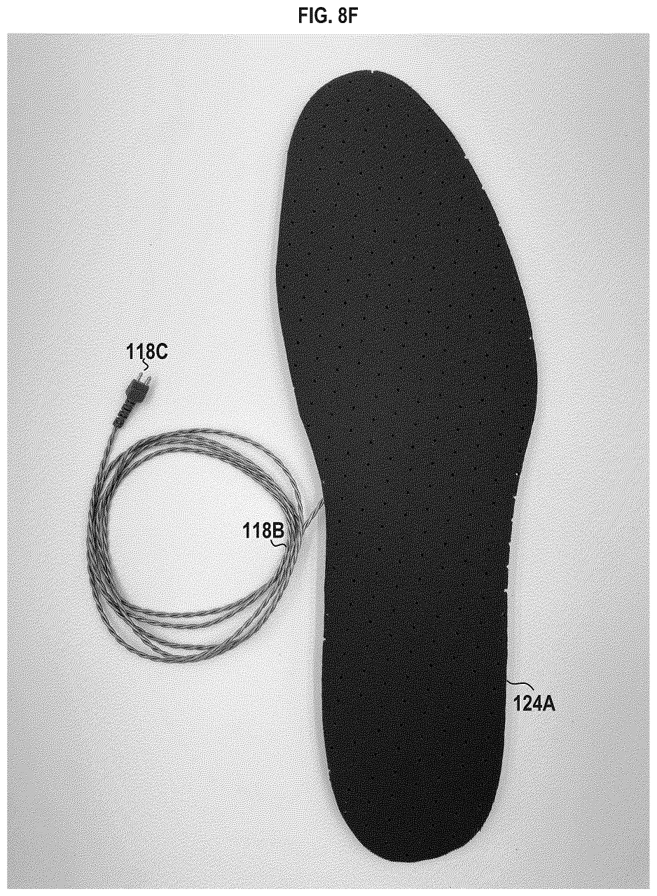

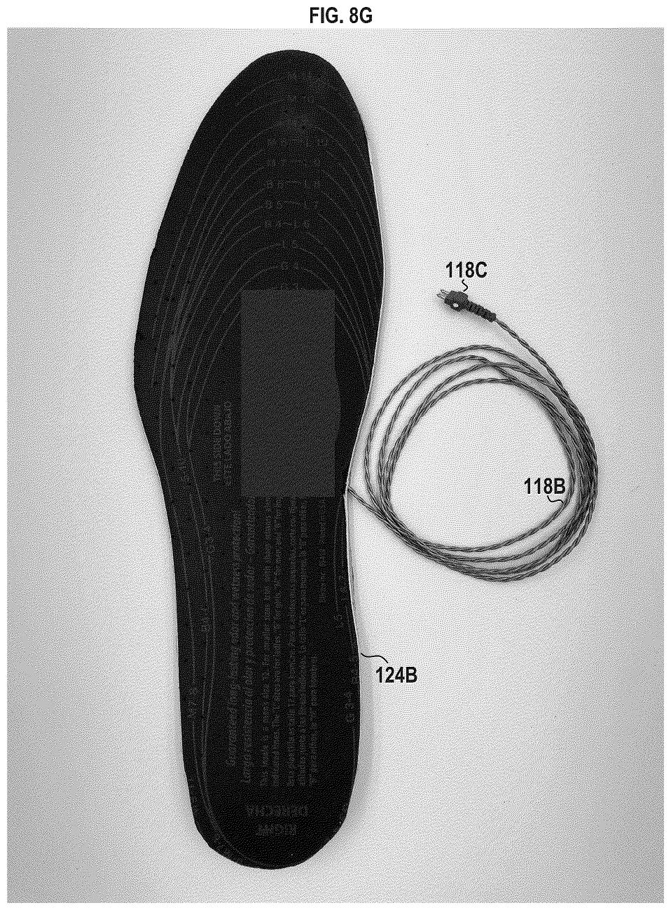

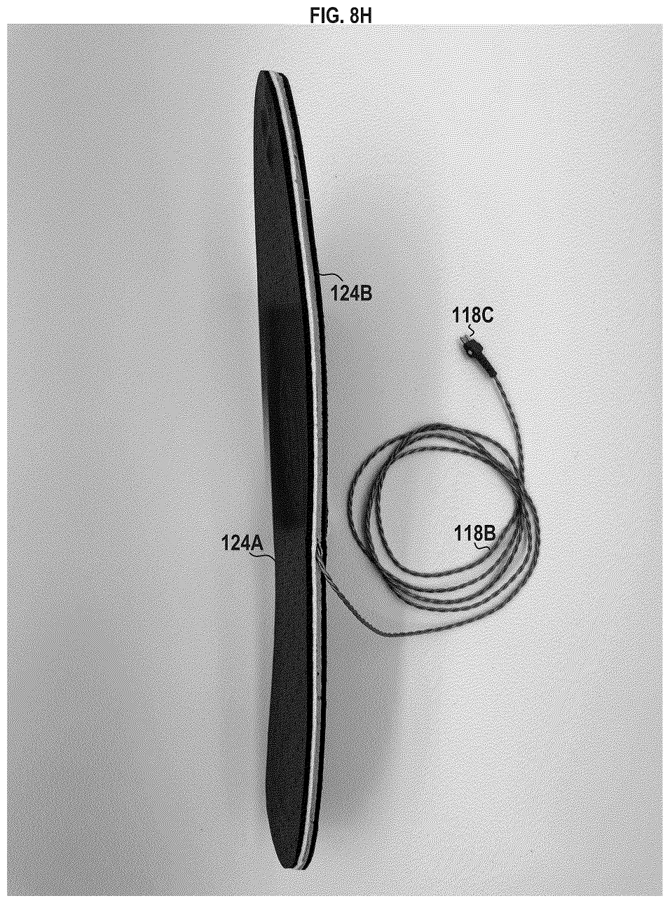

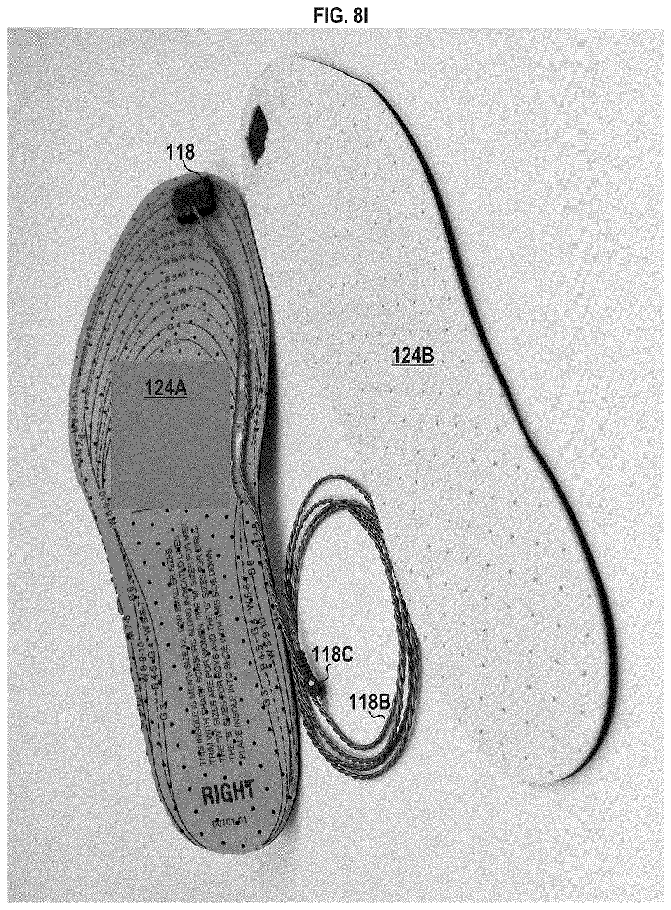

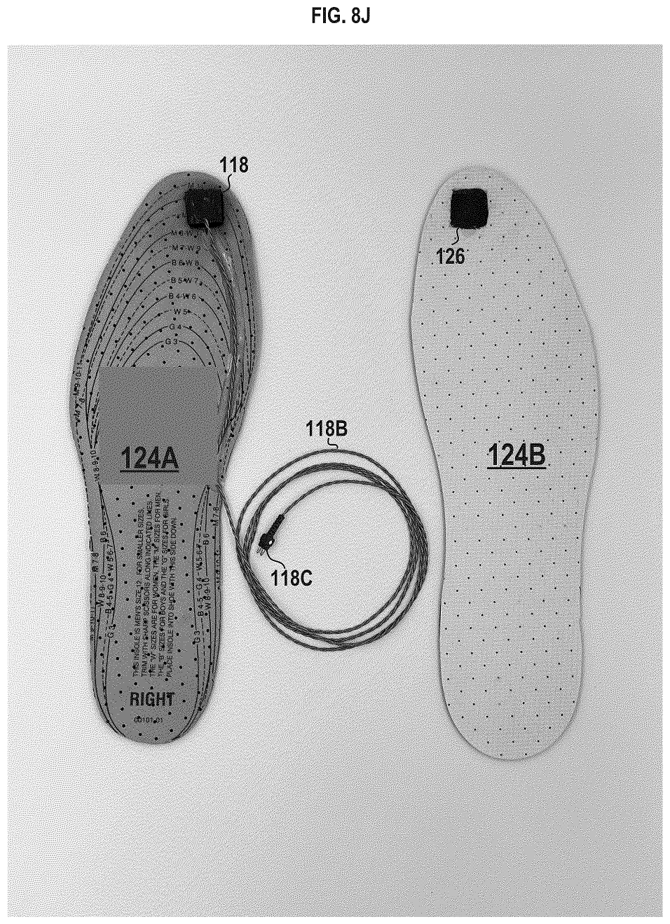

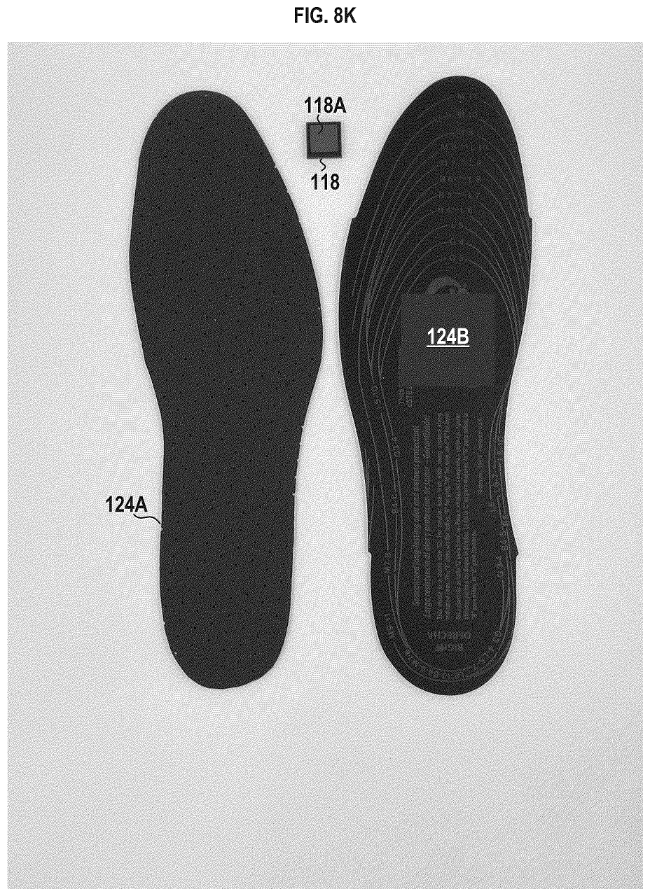

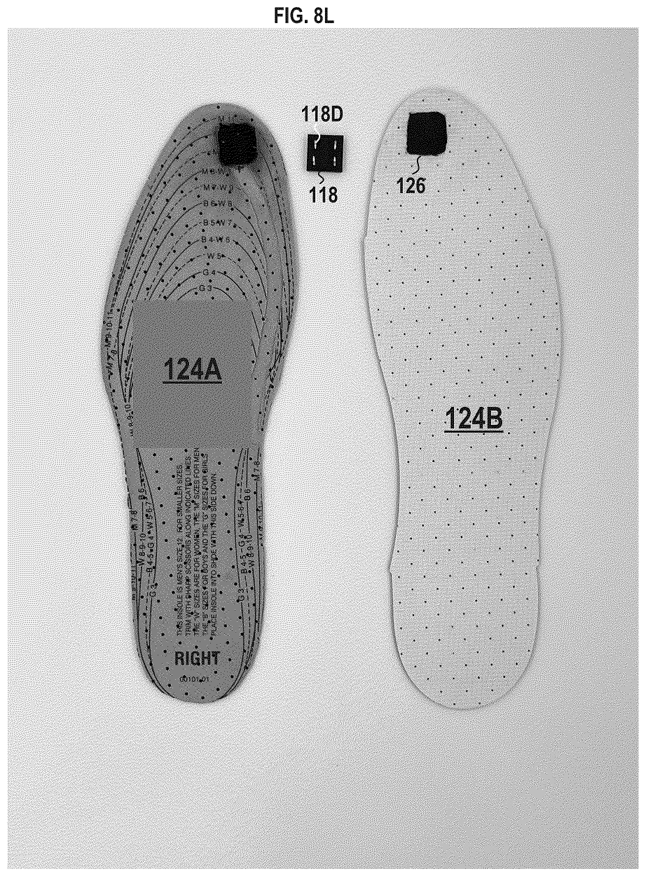

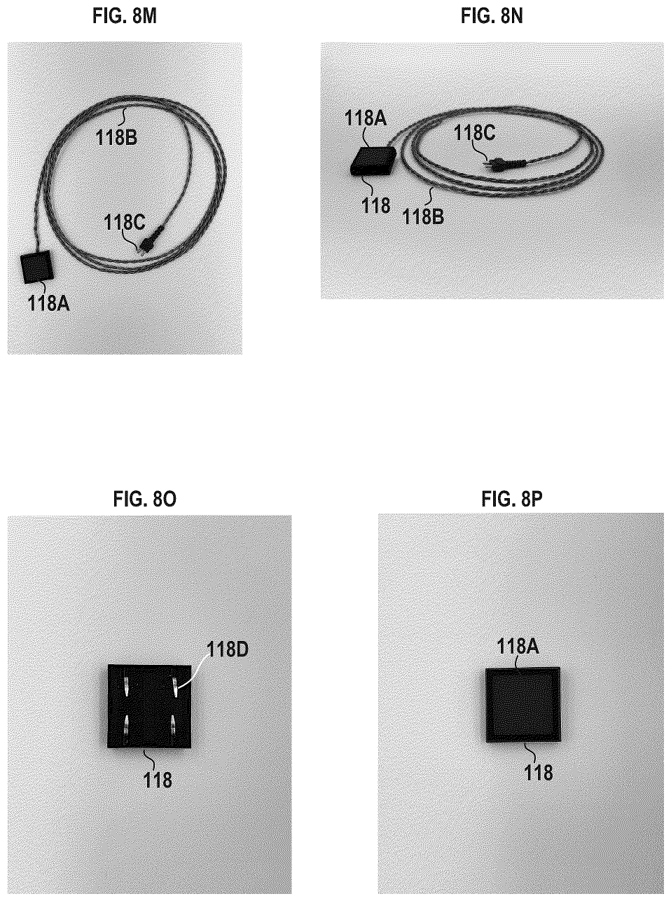

Referring to FIGS. 8A-8B, an example control mechanism for discrete audio playback is shown. The control mechanism may comprise the remote fob 108, a microswitch 118, and/or a trunkline connector 120 (e.g., a wire, cable, etc.). The control mechanism may allow for discreet operation, as the remote fob 108 may be concealed while the microswitch 118 may be positioned for easy access (and also concealed). The remote fob 108 may have a control button 108A, such as the one shown that is positioned in the center. To control the audio playback, the user may utilize the control mechanism (e.g., apply pressure to the control mechanism, apply pressure to a portion(s) of a wardrobe item comprising the control mechanism, depress a button(s) associated with the control mechanism, a combination thereof, and/or the like). For example, the user may hold the remote fob 108 in their hand or pocket, with the control button 108A easily accessible. Additionally, or in the alternative, the microswitch 118 may be connected to the remote fob 108, such as via a microswitch wire 118B and/or the trunkline connector 120, allowing for even more discreet control.

In some examples, the microswitch wire 118B may be designed with an adjustable length feature, allowing users to customize the positioning of the microswitch 118 based on their body type and clothing style. This may be achieved through a retractable mechanism or a series of detachable cable segments, for example. Furthermore, as shown in FIG. 8A, the trunkline connector 120 may connect the microswitch 118 (and corresponding microswitch wire 118B) to the remote fob 108. This may provide the user with a longer connection means between the microswitch 118 and the remote fob 108. Additionally, as further discussed below, use of the trunkline connector 120 may facilitate connecting multiple microswitches 118 to the remote fob 108.

The user may position the microswitch 118 with its microswitch button 118A in a convenient location, such as near their thigh, for easy activation. The microswitch button 118A may be a small component designed for user interaction (e.g., engagement, pressing, etc.). During a presentation, the user may use the microswitch button 118A or the control button 108A on the remote fob 108 to start and stop the audio playback via the audio device 104 as needed. The microswitch connector 118C may ensure a secure connection between the microswitch 118 and the remote fob 108, allowing for reliable control throughout the presentation.

In some aspects, alternative designs may be used for the microswitch 118. That is, the microswitch 118 shown in the figures is exemplary only. For example, the microswitch 118 may be, or comprise, a pressure-sensitive pad that may be integrated directly into clothing items. The pressure-sensitive pad may be sewn into a pocket lining or trouser fabric. The integration of pressure-sensitive functionality directly into clothing items may represent an advancement in the system's 100 discretion and usability. By integrating the pressure-sensitive pad into the fabric itself, the microswitch 118 may become more resistant to wear and tear compared to a separate microswitch 118. The pressure-sensitive area may be tailored to specific clothing items, allowing for optimal placement based on user preference and garment style and allowing for activation through natural movements, such as pressing against their thigh or chest, without the need to locate a specific button or switch. The pressure-sensitive clothing integration may align with the system's 100 goal of providing a covert, portable, and self-contained audio prompting solution. It may further enhance the user experience by eliminating the need for additional components while maintaining full functionality. This innovation may be valuable for professionals who require discreet audio cues while maintaining a natural and unencumbered appearance, such as public speakers, broadcasters, and performers.

In other cases, a small motion sensor may be incorporated into the microswitch 118 and/or the remote fob 108. The motion sensor may allow for gesture-based activation, such as a subtle tap or swipe, eliminating the need for a physical button or switch. This feature may allow users to control audio playback without the need for physical interaction with a button or switch, further enhancing the covert nature of the device and the system 100. Such gestures may be customized to perform various functions, such as starting or stopping audio playback, skipping to the next audio segment, or adjusting volume. The sensitivity of the motion sensor may be calibrated to minimize accidental activations while ensuring reliable response to intentional gestures.

In other examples, the microswitch 118 and/or the remote fob 108 may incorporate conductive fabric patches. Small patches of conductive fabric may be sewn into clothing at strategic locations. These patches may function as touch-sensitive areas that connect to (or serve as) the microswitch 118 and/or the remote fob 108. This configuration may allow for activation through light touch without the need for a physical switch or visible modifications to the clothing. The incorporation of conductive fabric patches may represent an innovative approach to further enhancing the discretion and usability of the microswitch 118 and/or the remote fob 108. By integrating these touch-sensitive areas directly into the user's clothing, the system 100 may achieve a new level of invisibility and ease of use. For example, one or more conductive fabric patches may be strategically placed in locations that are naturally easy for the user to access without drawing attention, such as the inside of a sleeve cuff, the side seam of trousers, or the edge of a jacket lapel. The patches may be connected to the microswitch 118 and/or the remote fob 108 through thin, flexible wires sewn into the clothing's lining, maintaining the garment's appearance and comfort. The touch-sensitive nature of these patches may allow for various control options. For example, a single tap may start or stop audio playback, while a double tap may skip to the next audio segment. More complex gestures, such as swipes or patterns, may be programmed for additional functions, providing users with a range of control options without the need to interact with a visible device

In some examples, the control mechanism may feature a biometric sensor. For example, a biometric sensor(s) may be integrated into the microswitch 118 and/or the remote fob 108. The biometric sensor may be a fingerprint sensor or a skin conductivity sensor, for example. This feature may add an extra layer of security, ensuring that only the authorized user can activate the system. In some variations, the control mechanism may incorporate a modular attachment system. For example, the system 100 may include interchangeable, modular microswitch 118 attachments. These attachments may include clip-on, adhesive, or magnetic options, for example.

Additionally, the microswitch 118 and/or the remote fob 108 may incorporate a small, highly directional microphone (or multiple microphones). This microphone may allow for voice-activated control using specific, discreet vocal commands. This feature may provide an alternative to physical interaction with the device. By utilizing a highly directional microphone, the system 100 may focus on capturing the user's voice while minimizing ambient noise, ensuring accurate command recognition even in noisy environments. The voice activation feature may be programmed to respond to specific, customizable phrases or keywords that are unlikely to be spoken in casual conversation, further enhancing the covert nature of the system 100. The voice activation feature may be particularly beneficial for users who need to maintain specific postures or gestures during their presentation or performance. Voice control may provide an alternative method for users with limited mobility or those who may find it challenging to operate physical buttons discreetly. Users may program personalized voice commands (e.g., via, or for controlling, the media device 106) that are natural and easy for them to remember, enhancing the system's 100 intuitiveness. Voice control may allow users to manage audio playback while simultaneously performing other tasks, such as gesturing or handling props during a presentation. Voice commands may be particularly useful in situations where physical access to the microswitch 118 and/or the remote fob 108 might be limited, such as during a seated interview or while wearing restrictive clothing. The implementation of voice-activated control may align with the system's 100 overall goal of providing a covert, portable, and self-contained audio prompting solution. It may further distinguish the invention from traditional prompting methods and enhance its effectiveness across various professional communication contexts, from public speaking to broadcasting and content creation. This feature, combined with the existing physical control options, may offer users flexibility in managing their audio prompts while maintaining a natural and unencumbered appearance.

The system 100 may incorporate one or more microphones to enable AI-assisted audio processing capabilities. In some implementations, microphones may be integrated into existing components of the system 100. For example, the earpiece 110 may include a small, directional microphone. Alternatively, the audio device 104 may incorporate multiple microphones arranged in an array configuration to capture audio from different directions. The system 100 may communicate with a Large Language Model (LLM) or similar AI system via the media hub 106. In some aspects, the media hub 106 may include additional processing capabilities or wireless connectivity to transmit the captured audio stream to a remote server hosting the LLM. The LLM may analyze the audio in real-time, processing speech, identifying questions, and generating relevant responses or commentary.

During a presentation or performance, the system 100 may provide the user with AI-generated answers to audience questions through the earpiece 110. The LLM may analyze the context of the presentation and the specific question asked, formulating an appropriate response that the user can relay to the audience. Additionally, the system may offer commentary or suggestions based on the analyzed audio, such as recommending clarification on a topic or suggesting relevant examples to enhance the user's explanation.

In some examples, the audio device 104 may be modified to include a high-quality omnidirectional microphone array. This configuration may capture audience questions more effectively. The media hub 106 may require additional processing power or cloud connectivity to handle real-time audio transmission to the LLM. The system may provide the user with concise answer suggestions through the earpiece 110, allowing for more dynamic and informed responses during Q&A sessions. Additionally, the LLM may analyze the user's speech in real-time, fact-checking statements and offering supplementary information when appropriate.

The system 100 may incorporate wearable microphones, such as lapel mics or smart glasses with integrated audio capture. These may connect wirelessly to the media hub 106. The LLM may analyze audience reactions, such as murmurs or side conversations, providing the user with suggestions to adjust their presentation style or content through the earpiece 110. This implementation may require additional software in the audio device 104 to process multiple audio streams simultaneously.

The system 100 may further incorporate retrieval-augmented generation (RAG) capabilities to enhance the AI-assisted functionality. In some implementations, the audio device 104 may include local storage for a RAG database containing domain-specific information relevant to the user's presentations or performances. Alternatively, the media hub 106 may establish a secure connection to a cloud-based RAG database via the network interfaces 1120 of computing device 1101. This database may store the user's personal presentation materials, frequently asked questions, technical specifications, or other reference materials that might be needed during a presentation.

When an audience member asks a question, the system 100 may leverage RAG technology to retrieve specific, factual information from the database rather than relying solely on the LLM's general knowledge. For example, if presenting technical product specifications, the system may query the RAG database for precise measurements, compatibility information, or pricing details that might not be included in the LLM's training data. This approach may significantly improve the accuracy and relevance of the information provided to the user through the earpiece 110, particularly for specialized or proprietary content. The RAG database may be customized and updated through the USB connection 104Q of the audio device 104 or wirelessly via the media hub 106. Users may prepare for specific presentations by loading relevant documents, research papers, product specifications, or previous Q&A sessions into the RAG database. During live presentations, the system 100 may automatically query this database when processing audience questions, retrieving the most relevant information based on semantic similarity to the current context. The retrieved information may then be synthesized by the LLM into concise, natural-language responses delivered through the earpiece 110.

To enable such RAG capabilities, the audio device 104 may be a computing device, such as a tablet, smartphone, specialized handheld device, or a custom-built digital recorder, that is purpose-built and/or purpose-configured specifically for implementing the RAG capabilities described in this application. This purpose-built configuration may include specialized hardware components optimized for natural language processing, dedicated memory partitions for the RAG database, and custom firmware designed to efficiently retrieve and process information during live presentations.

The purpose-built configuration of the audio device 104 for RAG capabilities represents a significant advancement in the system's functionality, particularly for real-time information retrieval and processing during presentations. The specialized hardware components optimized for natural language processing may include dedicated neural processing units (NPUs) or AI accelerators, which can significantly speed up the processing of language-based queries and responses. These components may enable the system to quickly understand and interpret user inputs, audience questions, or contextual cues, facilitating more natural and responsive interactions.

Dedicated memory partitions for the RAG database may ensure that relevant information is readily accessible, minimizing retrieval times and enhancing the system's ability to provide timely and accurate responses. This partitioning may involve the use of high-speed memory technologies, such as NVME SSDs or specialized in-memory databases, to further reduce latency in data access. The custom firmware designed for efficient retrieval and processing of information during live presentations may incorporate advanced algorithms for context-aware searching, real-time indexing, and adaptive learning. This firmware may be capable of prioritizing and pre-loading relevant information based on the current context of the presentation, anticipating potential questions or topics that may arise.

Furthermore, the purpose-built nature of the audio device 104 may extend to its physical design, incorporating features that enhance its usability in presentation settings. This could include tactile controls for discreet operation, high-capacity batteries for extended use without recharging, and robust wireless connectivity to ensure uninterrupted communication with the earpiece 110 and other system components. The device may also feature enhanced security measures, such as hardware encryption and biometric authentication, to protect sensitive presentation materials and personal data.

By integrating these advanced RAG capabilities directly into the audio device 104, the system provides presenters with a powerful tool for accessing and delivering information seamlessly during live presentations. This integration allows for more dynamic, informed, and engaging presentations, enabling speakers to address complex questions and adapt their content in real-time based on audience interactions and emerging discussion topics.

In some examples, the microswitch 118 may be configured with multiple activation patterns to control RAG functionality. For instance, a single press might activate standard LLM responses (or recorded responses), while a double press could trigger a more detailed RAG-enhanced response that includes specific citations or references from the database. This implementation may provide users with flexible control over the depth and specificity of information they receive through the earpiece 110. Additionally, the system 100 may incorporate adaptive learning capabilities, automatically identifying which information from the RAG database was most useful during presentations and prioritizing similar content in future sessions.

In some implementations as further described herein, the microswitch 118 may be incorporated into a shoe or shoe sole for activation with a toe. For example, the microswitch 118 may be embedded in the insole of a dress shoe, positioned beneath the ball of the foot or under the big toe. The microswitch button 118A may be designed as a thin, pressure-sensitive pad that responds to deliberate toe pressure. This configuration may allow the user to discreetly control audio playback by applying pressure with their toe, which may be particularly useful in situations where hand movements are limited or closely observed.

In another example, the microswitch 118 may be integrated into a piece of jewelry, such as a ring or bracelet. The microswitch button 118A may be disguised as a decorative element on the jewelry, allowing the user to activate it by touching or pressing the ornament. This approach may provide a fashionable and inconspicuous method of controlling the audio playback system. In a further example, the microswitch 118 may be incorporated into a pen or stylus. The microswitch button 118A may be positioned near the grip area, allowing the user to activate it with a subtle finger movement while appearing to simply hold or manipulate the writing instrument. This implementation may be particularly useful for speakers or presenters who frequently use visual aids or take notes during their presentations.

In some examples, the microswitch 118 may be designed as a small, self-contained unit that can be easily concealed in various locations. Such a wireless microswitch 118 may use Bluetooth Low Energy (BLE) or a similar short-range wireless protocol to communicate directly with the media hub 106 or the remote fob 108. The wireless microswitch 118 may include a built-in battery, allowing for extended use without the need for wired connections. This wireless design may offer greater flexibility in placement and use, as it eliminates the need for the microswitch wire 118B. The user may position the wireless microswitch 118 in a pocket, attach it to the inside of a garment, or even incorporate it into accessories like cufflinks or tie clips, providing numerous discreet control options without the constraints of wired connections.

In other examples, the microswitch 118 and/or the remote fob 108 may incorporate adhesive-backed and/or magnetic contact switches (e.g., for placement on an ankle(s), a wrist(s), and/or elsewhere). Additionally, or in the alternative, the microswitch 118 may incorporated into, controlled via, and/or in communication with a pair of eyeglasses worn by the user, such as “smart” and/or augmented-reality glasses, sunglasses, etc. The eyeglasses may display content on a lens(es), such as words, symbols, etc., that may be visible to the wearer/user but not perceptible to a nearby person(s) for example. The eyeglasses may incorporate the microswitch 118 into an arm(s) or other portion(s) of the eyeglasses to control playback. The eyeglasses may incorporate a small, highly directional microphone (or multiple microphones) to permit voice-activated control as discussed herein. Moreover, the microphone(s) incorporated into the eyeglasses (or into the microswitch 118, etc.) may permit voice detection, such as detecting when the user starts, or stops, speaking, and playback of the audio may correspondingly start, or stop, in real-time. The voice detection may also speed up, or slow down, the audio playback based the user's vocal cadence, for example. Processing of the user's detected speech (e.g., to enable the voice-activated control and/or the real-time playback speed adaptability described herein) may be performed by the media hub 106 and/or the audio device 104, in some examples. As mentioned, the earpiece 110 may utilize bone conduction technology. In some examples, the eyeglasses may utilize bone conduction technology, transmitting audio through the bones of the skull and leaving the ear canal open for ambient sound. Additionally, or in the alternative, the eyeglasses may be configured to track eye movement, blinking, touch, etc., to activate the microswitch 118 and/or the remote fob 108 (e.g., to control playback).

As a further example, the microswitch 118 may be incorporated into a shoe, boot, sock, and/or other foot covering, such that the microswitch 118 may be activated via a user's toe(s), heel, etc., via contact with the microswitch 118. In still further example, the microswitch 118 may be incorporated into a piece of jewelry, such as a necklace, a cufflink(s), a ring, etc., a microphone(s), a musical instrument(s), a stage prop, a presentation remote control, and/or a foot pedal. Other examples are possible as well.

In some examples, instead of a single microswitch 118, the system 100 may incorporate multiple connection points on the remote fob 108, allowing for simultaneous connection of microswitches 118 at different locations (e.g., thigh, wrist, and chest) via corresponding microswitch wires 118B and microswitch connectors 118C (and/or a single microswitch connector 118C accepting multiple microswitch wires 118B). This may provide users with flexibility in choosing the most comfortable or discreet activation point based on their specific situation. The incorporation of multiple connection points on the remote fob 108 for simultaneous microswitch 118 connections may enhance the system's 100 versatility and user-friendliness. This feature may address the diverse needs of users across various professional contexts and personal preferences. By allowing microswitches 118 to be connected at different locations such as the thigh, wrist, and chest, the system 100 may offer users flexibility in controlling their audio playback. This adaptability may be valuable in situations where certain body movements might be restricted or where discretion is paramount. Returning to FIG. 8A, in some examples, instead of (or in addition to) multiple connection points on the remote fob 108, multiple microswitches 118 may be connected to the remote fob 108 via the trunkline connector 120 (e.g., a “y-cable” design or similar). As shown in FIG. 8A, the trunkline connector 120 may comprise multiple microswitch connections 120A, 120B for multiple microswitch connectors 118C. Though only two microswitch connections 120A, 120B are shown, the trunkline connector 120 may comprise more than two in other examples. The trunkline connector 120 may facilitate connecting the multiple microswitches 118 to the remote fob 108 via a trunkline connector 120C.

For instance, a public speaker (e.g., user of the system 100) who frequently gesticulates may prefer a chest-mounted microswitch 118 for easy access without interrupting their hand movements. Conversely, a news anchor seated behind a desk may find a thigh-mounted microswitch 118 more convenient and less likely to be captured on camera. A performer in a theatrical production may opt for a wrist-mounted microswitch 118 that can be activated while maintaining character postures. Other examples are possible as well.

The multi-point connection feature of the microswitch 118 may also enhance the system's 100 reliability. For example, users may set up redundant microswitches 118 at different locations, ensuring they always have a backup method to control audio playback in case one becomes inaccessible or fails during use. This redundancy may be useful in high-stakes situations such as live broadcasts or important presentations where equipment failure is not an option. Moreover, this feature may allow users to experiment with different placements to find the most comfortable and intuitive configuration for their specific needs. The ability to customize microswitch 118 placement may reduce the learning curve associated with using the system 100, making it more accessible to a wider range of professionals.

The multi-point connection capability may also open up possibilities for more complex control schemes. For example, different microswitches 118 may be programmed to perform distinct functions, such as one for play/pause, another for skipping to the next audio segment, a third for volume control, etc. This level of customization may allow users to tailor the system's 100 functionality to their specific presentation or performance requirements. In line with the system's 100 overall goal of providing a covert, portable, and self-contained audio prompting solution, the multiple microswitch 118 placement options may further enhance its adaptability to various professional communication contexts. Whether used in public speaking, broadcasting, theatrical performances, or content creation, the multi-point connection capability may ensure that users can maintain a natural appearance and behavior while retaining full control over their audio prompts.

Still further, in some examples, to eliminate the need for cable routing, a wireless microswitch 118 may be developed. Such a wireless microswitch 118 may use a short-range, low-power wireless protocol to communicate with the remote fob 108, allowing for even more discreet placement without physical connections. For example, a wireless microswitch 118 may use Bluetooth Low Energy (BLE™) or Zigbee™ protocols, etc. These protocols are designed for minimal power consumption, which may be useful for maintaining extended battery life. The low power requirement may allow for a smaller battery, further reducing the overall size of the microswitch 118 and enhancing its concealability. By eliminating the need for physical cable connections between a wired microswitch 118 and the remote fob 108, a wireless microswitch 118 may allow for even more covert placement and operation. For example, the wireless microswitch 118 may be designed to closely resemble common objects such as buttons, cufflinks, or small decorative elements, further enhancing its discretion while maintaining full functionality.

Referring to FIGS. 8C-8E, detailed views of the remote fob 108 are shown. FIG. 8C shows a close-up example view of a portion of the remote fob 108, including a microswitch port 108B on the side of the remote fob 108. The microswitch 118 may be connected to the remote fob 108 via the microswitch wire 118B and the microswitch port 108B. FIG. 8D shows an exploded view of the remote fob 108 and its internal components, such as a circuit board 108C. The circuit board 108C may include one or more wires connecting the microswitch port 108B thereto and battery to power the remote fob 108. FIG. 8E shows another exploded view of the remote fob 108 and circuit board 108C with the one or more wires connecting the microswitch port 108B thereto.

The remote fob 108 may be designed with a compact form factor to facilitate discreet operation. In some aspects, the remote fob 108 may be small enough to be easily concealed in a pocket or under clothing. The microswitch port 108B of the remote fob 108 may allow for connection of external control devices, such as the microswitch(es) 118. This feature may enhance the flexibility of the remote fob 108, allowing users to customize the control interface based on their specific needs. The circuit board 108C may contain the core electronic components of the remote fob 108. In some cases, the circuit board 108C may include a microcontroller for processing user inputs and generating control signals. The circuit board 108C may also incorporate wireless communication components, such as a radio frequency (RF) transmitter, to send signals to other parts of the discrete audio playback system.

In some aspects, the remote fob 108 may be designed for easy assembly and disassembly. This feature may facilitate maintenance, battery replacement, or upgrades to the device. The compact design of the remote fob 108 may require careful arrangement of components on the circuit board 108C to maximize functionality while minimizing size. The remote fob 108 may incorporate various power-saving features to extend battery life. In some cases, the remote fob 108 may enter a low-power sleep mode when not in use, waking up quickly when activated by a user input (e.g., via the microswitch 118).

In some variations, the remote fob 108 may include additional features not visible in the Figures. For example, the remote fob 108 may incorporate haptic feedback mechanisms to provide tactile confirmation of button presses or system status updates. The remote fob 108 may also include internal memory for storing user preferences or system settings. In some embodiments, the remote fob 108 may feature a small e-ink display for visual feedback and system control. Other examples are possible as well.

FIGS. 8F-8P show further examples of the microswitch 118. In some implementations, the microswitch 118 may be incorporated into a shoe or shoe sole for activation with a toc. For example, as shown in FIGS. 8F-8G, the microswitch 118 may be embedded between an insole top 124A and an insole bottom 124B of a shoe. The insole top 124A may conceal the presence of the microswitch 118. The microswitch wire 118B may extend from the microswitch 118 and terminate in a microswitch connector 118C. The microswitch connector 118C may be designed to interface with other components of the system 100, such as the remote fob 108 (e.g., via connection to the trunkline connector 120C mentioned above). The microswitch wire 118B may be configured as a twisted pair cable to minimize electromagnetic interference and ensure reliable signal transmission from the microswitch 118 to other system components.

FIG. 8G shows an insole bottom 124B with the microswitch wire 118B terminating in the microswitch connector 118C. The microswitch wire 118B may be designed to be thin and flexible, allowing it to be routed discreetly along the edge of the insole bottom 124B without creating discomfort for the user. In FIG. 8H, the microswitch wire 118B is shown with a thin profile, specifically designed to fit between the insole top 124A and the insole bottom 124B without creating discomfort for the wearer. The minimal thickness of the microswitch wire 118B allows it to be sandwiched between the two insole layers while maintaining the natural contour and comfort of the footwear. Due to this ultra-thin design, a user wearing the insole would likely be unaware of the presence of the microswitch wire 118B, as it creates no perceptible pressure points or irregularities in the insole's surface. This design consideration may be crucial for maintaining both the discretion and comfort of the system 100, allowing the user to walk naturally without any indication that technology has been integrated into their footwear.

As illustrated in FIG. 8I, the microswitch wire 118B may extend from the microswitch 118 and terminate in a microswitch connector 118C. A microswitch mounting point 126 may be visible near the top portion of the insole top 124A as shown in FIG. 8J. The microswitch mounting point 126 may be specifically designed as a recessed area or reinforced section shaped to securely accommodate the microswitch 118 when the insole top 124A and insole bottom 124B are assembled together.

In FIG. 8K, the insole top 124A and the insole bottom 124B are shown with the microswitch 118 having a microswitch button 118A. The microswitch button 118A may be designed as a thin, pressure-sensitive pad that responds to deliberate toe pressure. The red color of the microswitch button 118A may be for illustration purposes only, and the actual implementation may use a color that blends with the insole materials for better concealment. In FIG. 8L, a microswitch mounting point 126 may be visible on the insole top 124B. The microswitch mounting point 126 may be specifically designed to align with the ball of the foot or the area under the big toc, where a user may most naturally apply pressure.

As described herein, the microswitch 118 may be connected to the microswitch wire 118B. FIGS. 8L and 80 show an example microswitch terminal 118D. The microswitch 118 may be connected to the microswitch wire 118B at/via the microswitch terminal 118D. In FIGS. 8M-8P, various configurations of the microswitch 118 are illustrated. The microswitch 118 designed for insole integration may feature a significantly flatter profile than versions designed for finger activation. This flattened design may distribute pressure across a wider area to prevent discomfort during extended walking periods. The insole-specific microswitch 118 may also incorporate waterproofing materials to protect against moisture from foot perspiration. An activation force threshold may be calibrated higher for toc activation compared to finger-activated versions. This calibration may prevent accidental triggering during normal walking motions while still allowing for deliberate activation. The microswitch wire 118B may be specially shielded against abrasion and compression forces unique to footwear environments. The microswitch button 118A may incorporate tactile feedback elements to provide confirmation of activation through the insole material. This feedback may be particularly important when the user cannot visually confirm activation. Other examples are possible as well.

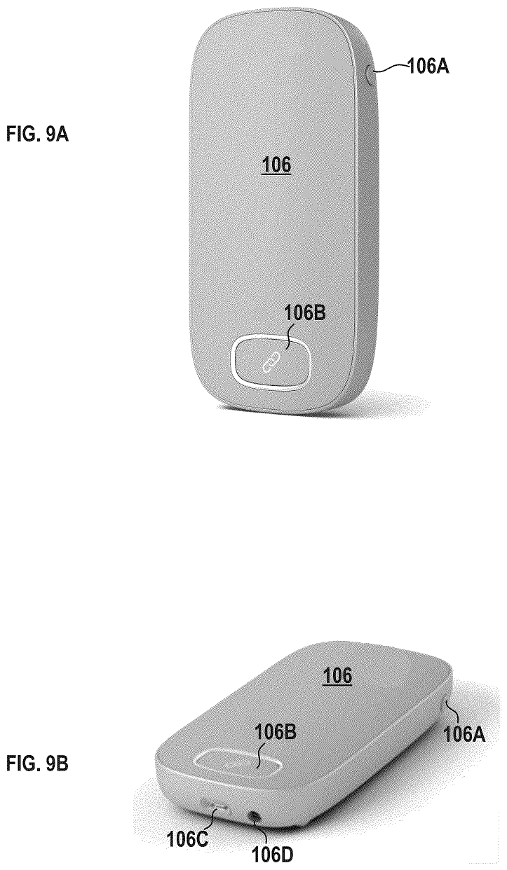

Turning now to FIGS. 9A-9B, an example of the media hub 106 is shown. The media hub 106 may comprise a connect button 106B, a power button 106A, a charging port 106C, and/or an output jack 106D. In some aspects, the media hub 106 may be designed to support multiple frequency bands The media hub 106 may operate on 2.4 GHZ, 5 GHZ, and sub-GHz frequencies, for example. This multi-band support may enhance the versatility of the media hub 106, allowing it to adapt to various environmental conditions and user requirements. The media hub 106 may incorporate adaptive frequency hopping in certain cases. This feature may enhance signal reliability by dynamically switching between available channels within the supported frequency bands. The adaptive frequency hopping may help mitigate interference from other wireless devices and improve overall connection stability.

In some variations, the media hub 106 may include beamforming capabilities. Beamforming technology may allow the media hub 106 to focus the wireless signal towards the earpiece 110. This focused transmission may potentially increase range, improve signal quality, and reduce power consumption. In some variations, the media hub 106 may support simultaneous connections to multiple earpieces, allowing for backup options or shared listening experiences. The media hub 106 may enable mesh networking functionality in certain aspects. This feature may extend the range and coverage of the system 100 by allowing multiple media hubs to work together. In a mesh network configuration, each media hub 106 may act as a node, relaying signals to other nodes and expanding the overall coverage area. In some cases, the media hub 106 may implement advanced encryption protocols and secure pairing mechanisms. These security features may protect the audio transmission from interception or unauthorized access. A secure pairing process may involve a unique digital code exchange between the media hub 106 and the earpiece 110, making the audio signal virtually impossible to intercept.

The media hub 106 may incorporate power optimization techniques in some variations. These techniques may include automatic sleep modes and dynamic power adjustment based on signal strength and quality. Such features may extend battery life for both the media hub 106 and the connected earpiece 110. For example, the media hub 106 may incorporate smart power management features to optimize energy consumption and extend battery life. In some aspects, the media hub 106 may include automatic sleep modes that activate during periods of inactivity. The media hub 106 may dynamically adjust its power output based on factors such as signal strength, distance from the earpiece 110, and ambient electromagnetic interference. This adaptive power management may help balance performance and energy efficiency.

In certain cases, the media hub 106 may be designed to maintain simultaneous connections with two or more earpieces 110. This multi-connectivity feature may provide redundancy in case of signal loss or battery depletion in one earpiece 110. The media hub 106 may enable seamless switching between primary and backup earpieces 110, ensuring uninterrupted audio playback in critical situations. The media hub 106 may also implement advanced audio processing algorithms to enhance sound quality. In some variations, automatic gain control may be incorporated to maintain consistent audio levels across different input sources or environmental conditions. The media hub 106 may also feature noise reduction algorithms that help isolate and clarify the desired audio signal, particularly in challenging acoustic environments.

The media hub 106 may integrate with a smartphone application in certain cases. As an example, the media hub 106 may establish a Bluetooth connection with a user's smartphone, enabling additional control options and system 100 monitoring capabilities. Through this integration, users may be able to adjust audio settings, monitor battery levels, update firmware directly from their smartphone, etc. The smartphone application may also provide a user-friendly interface for managing audio content and customizing the behavior of the system 100. Other examples are possible as well.

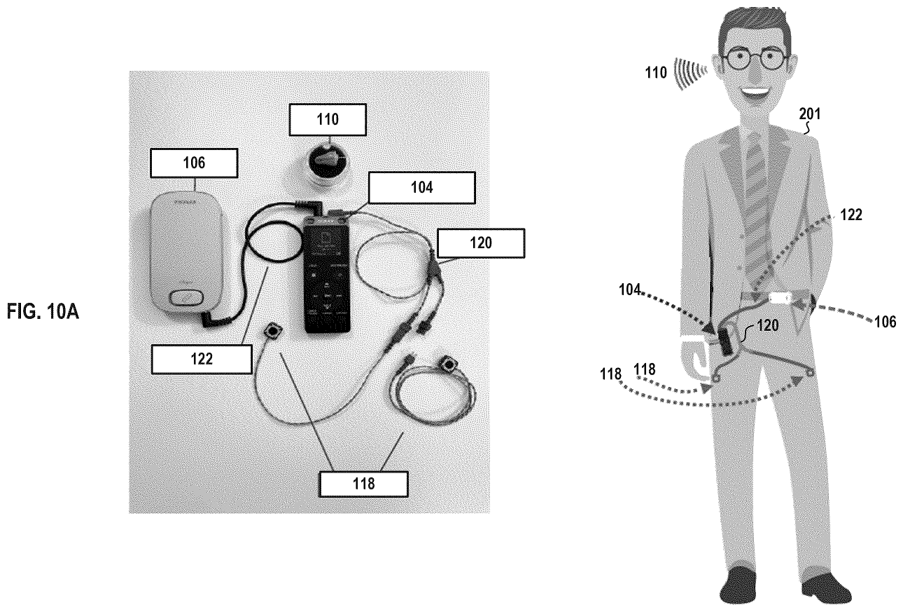

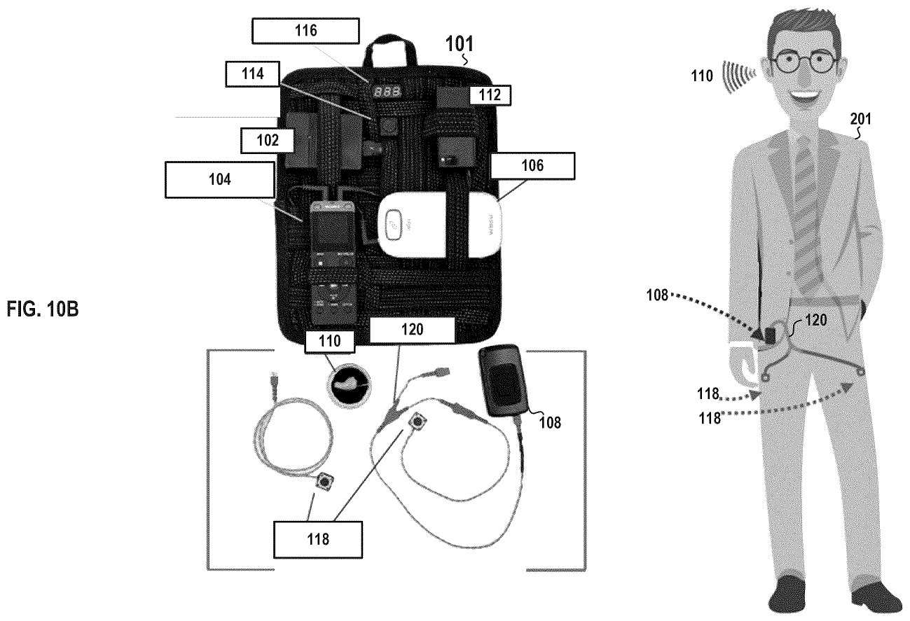

Referring to FIGS. 10A-10B, example views of a user 201 wearing components of the system 100 in two different configurations are shown. The configuration in FIG. 10A may be suitable when the user 201 wishes to have as much freedom of movement as possible, as the necessary components from the system 100, shown on the left-hand side of FIG. 10A, may all be on the user's 201 person and/or proximate thereto (e.g., in the user's 201 pocket, hand, etc.). For example, as shown in FIG. 10A, the user 201 may wear the earpiece 110, the media hub 106 may be attached to the user's 201 belt or waistband, while the audio device 104 may be in the user's 201 pocket, etc. The media hub 106 may connect to the audio device 104 via an audio cable 122, and one or more microswitches 118 may connect to the audio device 104 via the trunkline connector 120. The one or more microswitches 118 may be located in the user's 201 pocket, secured to the user's 201 body/skin, and/or elsewhere, as described herein.

FIG. 10B may display the same user 201 with a modified configuration of the system 100. The configuration in FIG. 10B may be suitable when the user 201 may not require as much freedom of movement and/or when the user 201 desires to have fewer components of system 100 to be on the user's 201 person. For example, the user 201 may be proximate to the container 101 housing some of the components of the system 100 as shown in FIG. 10B, as compared to the configuration shown in FIG. 10A. For example, as shown in FIG. 10B, the earpiece 110 may still be present; the remote fob 108 may be in the user's 201 pocket, for example; and the microswitch(es) 118 and the trunkline connector 120 may be in a same or similar position as in FIG. 10A. However, in the configuration shown in FIG. 10B, the audio device 104 and the media hub 106 may not be with the user 201 and may instead be elsewhere, such as in the container 101 (e.g., within range of the earpiece 110). FIGS. 10A-10B demonstrate how the components of the system 100 may be worn and concealed on the user's 201 person in different arrangements. The system 100 may be configurable to adapt to different user 201 preferences and situational requirements. In some aspects, users 201 may choose to wear only certain components based on their specific needs. The flexibility in component placement and configuration may allow users 201 to maintain a professional appearance while benefiting from the discrete audio playback capabilities. Additionally, it is to be understood that the configurations shown in FIGS. 10A-10B are demonstrative only, and the components of the system 100 may be arranged in a variety of ways.

As described herein, the configuration in FIG. 10A may be suitable when the user 201 wishes to have as much freedom of movement as possible. The necessary components from the system 100, shown on the left-hand side of FIG. 10A, may all be on the user's 201 person and/or proximate thereto (e.g., in the user's 201 pocket, hand, etc.). The configuration may also incorporate a toe-activated microswitch 118, such as the one shown in FIG. 8F. The toe-activated microswitch 118 may be embedded between an insole top 124A and an insole bottom 124B of the user's 201 shoe. The microswitch wire 118B may extend up from the user's 201 leg to connect with the remote fob 108—either directly (microswitch wire 118B to the remote fob 108) or via connection of the microswitch wire 118B to the trunkline connector 120, which would connect to the remote fob 108. This configuration may be particularly useful for presenters who need to maintain specific hand gestures or positions during their presentation. For example, a conductor leading an orchestra may utilize the toe-activated microswitch 118 to receive audio cues about upcoming musical passages without interrupting their conducting motions. The conductor may activate the microswitch 118 with a subtle toe press whenever they need to hear the next instruction or reminder.

As described herein, the configuration in FIG. 10B may be suitable when the user 201 may not require as much freedom of movement and/or when the user 201 desires to have fewer components of system 100 to be on the user's 201 person. The configuration may also incorporate a toe-activated microswitch 118, such as the one shown in FIG. 8F. The toc-activated microswitch 118 may be embedded between an insole top 124A and an insole bottom 124B of the user's 201 shoe. The microswitch wire 118B may extend up from the user's 201 leg to connect with the remote fob 108—either directly (microswitch wire 118B to the remote fob 108) or via connection of the microswitch wire 118B to the trunkline connector 120, which would connect to the remote fob 108. This configuration may be particularly useful for presenters who need to maintain specific hand gestures or positions during their presentation.

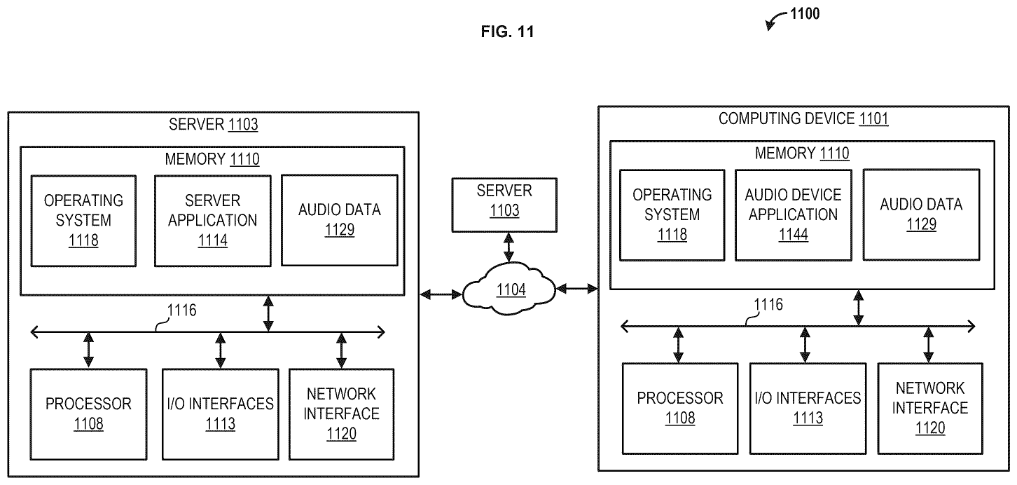

The present methods and systems may be computer-implemented. FIG. 11 shows a block diagram depicting a system/environment 1100 comprising non-limiting examples of a computing device 1101 and a server 1103 connected through a network 1104. Either of the computing device 1101 or the server 1103 may be a computing device, such as any of the devices of the system 100 shown in FIG. 1. In some aspects, some or all steps of any described method may be performed on a computing device as described herein. The computing device 1101 may comprise one or multiple computers configured to store audio data 1129, and/or the like. The server 1103 may comprise one or multiple computers configured to store a server application 1114. Multiple servers 1103 may communicate with the computing device 1101 via the network 1104.

The computing device 1101 and the server 1103 may be a digital computer that, in terms of hardware architecture, generally includes a processor 1108, system memory 1110, input/output (I/O) interfaces 1113, and network interfaces 1120. These components may be communicatively coupled via a local interface 1116. The local interface 1116 may be, for example, but not limited to, one or more buses or other wired or wireless connections, as is known in the art. The local interface 1116 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 1108 may be a hardware device for executing software, particularly that stored in system memory 1110. The processor 1108 may be any custom made or commercially available processor, a central processing unit (CPU), an auxiliary processor among several processors associated with the computing device 1101 and the server 1103, a semiconductor-based microprocessor (in the form of a microchip or chip set), or generally any device for executing software instructions. When the computing device 1101 and/or the server 1103 is in operation, the processor 1108 may execute software stored within the system memory 1110, to communicate data to and from the system memory 1110, and to generally control operations of the computing device 1101 and the server 1103 pursuant to the software.

The I/O interfaces 1113 may be used to receive user input from, and/or for providing system output to, one or more devices or components. User input may be provided via, for example, a keyboard and/or a mouse. System output may be provided via a display device and a printer (not shown). I/O interfaces 1113 may include, for example, a serial port, a parallel port, a Small Computer System Interface (SCSI), an infrared (IR) interface, a radio frequency (RF) interface, and/or a universal serial bus (USB) interface.

The network interface 1120 may be used to transmit and receive from the computing device 1101 and/or the server 1103 on the network 1104. The network interface 1120 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The network interface 1120 may include address, control, and/or data connections to enable appropriate communications on the network 1104.

The system memory 1110 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 1110 may incorporate electronic, magnetic, optical, and/or other types of storage media. In some cases, the system memory 1110 may have a distributed architecture, where various components are situated remote from one another, but may be accessed by the processor 1108.

The software in system memory 1110 may include one or more software programs, each of which comprises an ordered listing of executable instructions for implementing logical functions. In the example of FIG. 11, the software in the system memory 1110 of the computing device 1101 may comprise the audio data 1129, the sever application 1124, and a suitable operating system (O/S) 1118. In the example of FIG. 11, the software in the system memory 1110 of the server 1103 may comprise the audio data 1129, the server application data 1124, and a suitable operating system (O/S) 1118. The operating system 1118 may control the execution of other computer programs and provide scheduling, input-output control, file and data management, memory management, and communication control and related services.

For purposes of illustration, application programs and other executable program components such as the operating system 1118 are shown herein as discrete blocks, although it is recognized that such programs and components may reside at various times in different storage components of the computing device 1101 and/or the server 1103. An implementation of the system/environment 1100 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

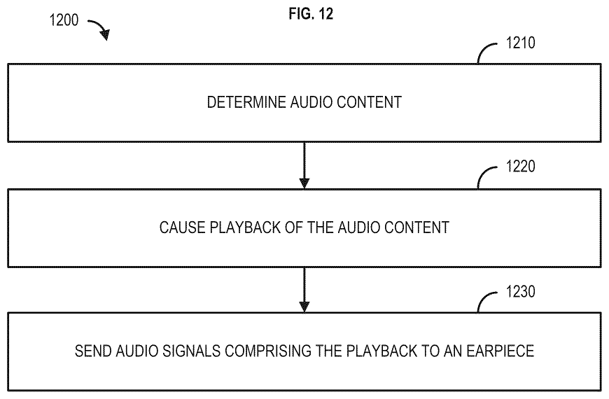

FIG. 12 shows a flowchart of a method 1200 for discrete audio playback. The method 1200 may be performed in whole or in part by a single computing device, a plurality of computing devices, and the like. For example, some or all steps of the method 1200 may be performed by at least one of the devices shown in FIG. 1 (e.g., one or more devices of the system 100). At step 1210, audio content may be determined. For example, a user may make a selection of audio content from a collection of pre-recorded audio files stored on the audio device 104. The user may navigate through stored audio files using the control buttons on the audio device 104, such as the up button 104E, down button 104F, left button 104G, and right button 104H, etc., to select one or more of the audio content.

At step 1220, the audio device 104 may be played back/output. For example, a control mechanism, which may comprise at least one microswitch 118 and/or at least one remote fob 104, may be activated to cause playback of the audio content via the audio device 104. For example, the user may engage/press the microswitch button 118A to activate the microswitch 118. The microswitch 118 may be connected to the remote fob 108 via the microswitch wire 118B, as an example, allowing for discreet control of the audio playback. At step 1230, an audio signal(s) comprising the playback of the audio content may be sent to earpiece 110. For example, the selected audio content may be output via the audio device 104, and a corresponding audio signal/stream may then be transmitted from the audio device 104 to the media hub 106, which may then wirelessly transmit the audio to the earpiece 110 to output the selected audio content.

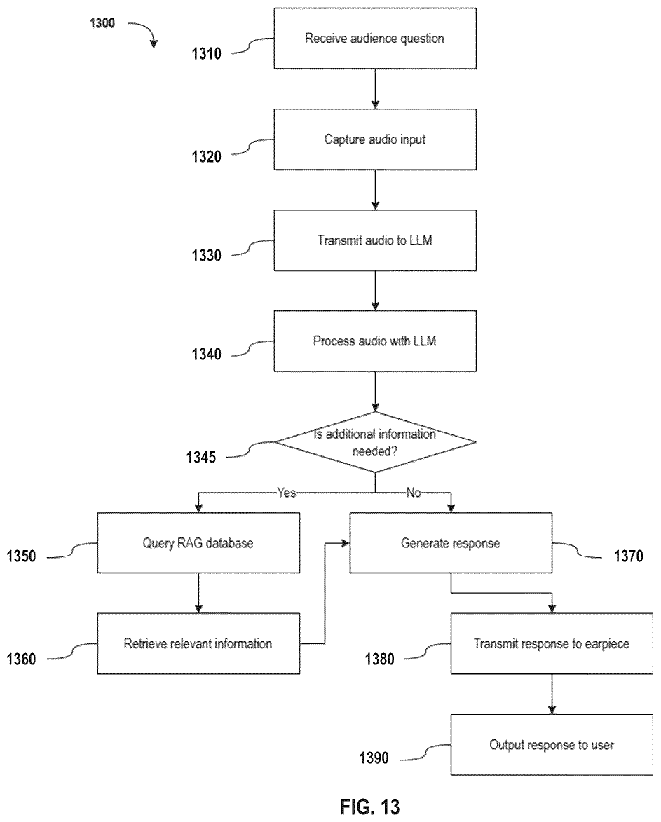

FIG. 13 shows a flowchart of a method 1300 for processing audio input and generating responses. The method 1300 may be performed in whole or in part by a single computing device, a plurality of computing devices, and the like. For example, some or all steps of the method 1300 may be performed by at least one of the devices shown in FIG. 1 (e.g., one or more devices of the system 100). At step 1310, an audience question may be received. For instance, during a presentation or Q&A session, an audience member may pose a question to the user of the system 100.

At step 1320, audio input may be captured. For example, the system 100 may utilize a microphone or similar audio input device to record the audience question. The captured audio may then be transmitted to a Large Language Model (LLM) at step 1330. This transmission may occur via the network 1104 to a server 1103 hosting the LLM, for instance. It should be noted that in some examples the step 1310 is not performed, as the audio input may be captured on a rolling basis and/or every so often in order to determine when a question has been asked. Additionally, or in the alternative, the user may cause particular audio to be analyzed via voice command and/or a particular series of button presses at the microswitch 118.

At step 1340, the audio may be processed with the LLM. The LLM may analyze the content of the question and prepare a response. Following this, at step 1345, the method 1300 may determine if additional information is needed to formulate a comprehensive response. If additional information is needed, the method 1300 may proceed to step 1350, where a RAG (Retrieval-Augmented Generation) database may be queried. This database may contain specialized or contextual information relevant to the presentation topic. At step 1360, relevant information may be retrieved from the RAG database.

Whether additional information was needed or not, the method 1300 proceeds to step 1370, where a response is generated. This response may incorporate information from the LLM processing and, if applicable, the RAG database retrieval. At step 1380, the generated response may be transmitted to an earpiece, such as the earpiece 110. Finally, at step 1390, the response may be output to the user, allowing them to hear the AI-generated answer through the earpiece 110 and relay it to the audience.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A system for discrete audio playback, comprising:
an audio device configured to store and playback pre-recorded audio files;
a wireless earpiece configured to receive audio signals wirelessly;
a media hub configured to wirelessly transmit audio signals from the audio device to the wireless earpiece;
a remote fob configured to control audio playback;
at least one wardrobe item; and
a microswitch operatively connected to the remote fob, wherein the microswitch is concealed within the at least one wardrobe item, wherein the media hub transmits audio signals, comprising one or more of the pre-recorded audio files, from the audio device to the wireless earpiece in response to activation of the microswitch via the at least one wardrobe item.

2. The system of claim 1, wherein the activation of the microswitch via the at least one wardrobe item comprises application of pressure to at least one portion of the at least one wardrobe item.

3. The system of claim 1, wherein the microswitch is connected to the remote fob via a wire, and wherein the wire connecting the microswitch to the remote fob has an adjustable length.

4. The system of claim 1, wherein the microswitch is wirelessly connected to the remote fob.

5. The system of claim 1, wherein the microswitch is integrated into a piece of clothing.

6. The system of claim 5, wherein the microswitch comprises a pressure-sensitive pad sewn into the clothing.

7. The system of claim 1, wherein the remote fob comprises multiple connection points for simultaneous connection of multiple microswitches.

8. The system of claim 1, wherein the microswitch is activated by a gesture-based input.

9. The system of claim 1, wherein the microswitch comprises a biometric sensor for user authentication.

10. A method comprising:
determining, based on a user input at an audio device, a selection of audio content from a collection of pre-recorded audio files;
causing, based on an activation of a control mechanism, playback of the selected audio content via the audio device, wherein the control mechanism is concealed within a wardrobe item and is in communication with the audio device via a media hub; and
sending, via the media hub, audio signals comprising the playback to an earpiece, wherein the media hub sends the playback to the earpiece in response to activation of the control mechanism via the wardrobe item.

11. The method of claim 10, wherein the control mechanism comprises a microswitch, and wherein the activation of the control mechanism via the wardrobe item comprises application of pressure to at least one portion of the wardrobe item concealing the microswitch.

12. The method of claim 11, wherein the microswitch comprises a button configured to initiate the playback when pressed.

13. The method of claim 10, wherein the microswitch is coupled to a remote fob, and wherein the remote fob causes the playback of the selected audio content via the audio device and the media hub, and wherein the remote fob comprises multiple connection points for simultaneous connection of multiple microswitches.

14. The method of claim 10, further comprising:
sending an audio input to a large language model (LLM);
querying, via the LLM and based on the audio input, a retrieval-augmented generation (RAG) database for relevant information;
receiving, via the RAG database, the relevant information, wherein the relevant information is associated with the audio input; and
sending, via the media hub, audio signals comprising second playback to the earpiece, wherein the second playback comprises the relevant information.

15. A method comprising:
receiving, based on a presentation being conducted, an audio input;
sending, based on the audio input being received, the audio input to a large language model (LLM);
causing, based on the audio input being sent to the LLM, processing of the audio input with the LLM to generate a preliminary response;
determining, based on the preliminary response, if additional information is needed for a final response;
causing, based on a determination that additional information is needed, querying of a retrieval-augmented generation (RAG) database;
receiving, based on the querying of the RAG database, relevant information from the RAG database; and
generating, based on the preliminary response and any received relevant information, the final response.

16. The method of claim 15, further comprising sending, based on the final response being generated, the final response to a wireless earpiece for output to a user.

17. The method of claim 15, wherein the audio input is captured using a microphone integrated into a presentation device.

18. The method of claim 15, wherein the determination of additional information is based on the complexity of the audio input.

19. The method of claim 15, further comprising causing, based on the final response being generated, storage of the final response in a database for future reference.

20. The method of claim 15, wherein the LLM is hosted on a remote server and accessed via a network connection.
